(19) United States
(12) Patent Application Publication
(10) Pub. No.: US 2016/0147347 A1
(43) Pub. Date: May 26, 2016

(54) TOUCH DISPLAY DEVICE AND MANUFACTURING METHOD THEREOF

(71) Applicant: Innolux Corporation, Miao-Li County (TW)

(72) Inventors: Ker-Yih Kao, Miao-Li County (TW); Huei-Ying Chen, Miao-Li County (TW)

(21) Appl. No.: 14/943,141

(22) Filed: Nov. 17, 2015

(30) Foreign Application Priority Data
Nov. 21, 2014 (TW) 103140418

(51) Int. Cl. G06F 3/041

(52) U.S. Cl. CPC G06F 3/0412; G06F 2203/04103

(57) ABSTRACT

A touch display device and a manufacturing method thereof are provided. The touch display device includes a display module and a touch module disposed on the display module. The touch module includes a patterned metal layer and an antireflection layer. The patterned metal layer includes a plurality of metal lines. The pattern metal layer has a first region. At least one of the metal lines in the first region has a top surface, a first sidewall, and a second sidewall opposite to the first sidewall. The antireflection layer is formed on the first region, wherein the antireflection layer covers the top surface and the first sidewall, and the second sidewall of at least one of the metal lines in the first region.

This application claims the benefit of Taiwan application Serial No. 103140418, filed Nov. 21, 2014, the subject matter of which is incorporated herein by reference.

### BACKGROUND OF THE INVENTION

1. Field of the Invention

The present disclosure relates in general to a touch display device and a manufacturing method thereof, and more particularly to a touch display device with excellent display quality and a manufacturing method thereof.

2. Description of the Related Art

In recent years, along with the research and developments in various electronic products, such as smartphones and PC Tablets, the operation interfaces for electronic products are more and more user-friendly. For example, with a touch element being added to the electronic product, the user can directly perform various operations on the touch screen by using a finger or a touch pen instead of using an input device such as a keyboard or press keys.

Conventionally, touch sensing elements are formed of indium tin oxide (ITO) films. As the size of the display device is getting larger and larger, conductive layers are formed of metal materials instead of ITO films in the industries. For example, a conductive layer may be formed of a metal mesh. However, when the conductive layer is formed of a metal material, which has high reflectivity, the display surface reflects lights and makes the display quality deteriorate. Therefore, how to provide a touch display with excellent display quality has become a prominent task for the industries.

### SUMMARY OF THE INVENTION

The present disclosure is directed to a touch display device in which the antireflection layer covers a top surface and two sidewalls of at least one of the metal lines formed on the patterned metal layer. Since the patterned metal layer can be completely covered, the reflection on the display surface can be reduced, and the display quality of the touch display device can be increased accordingly.

According to one embodiment the present disclosure, a touch display device is provided. The touch display device includes a display module and a touch module disposed on the display module. The touch module includes a patterned metal layer and an antireflection layer. The patterned metal layer includes a plurality of metal lines. The pattern metal layer has a first region. At least one of the metal lines in the first region has a top, a first sidewall, and a second sidewall opposite to the first sidewall. The antireflection layer is formed on the first region, wherein the antireflection layer covers the top surface, the first sidewall, and the second sidewall of the at least one of the metal lines in the first region.

According to another embodiment the present disclosure, a manufacturing method of touch display device is provided. The manufacturing method of touch display device includes following steps: A display module is provided. A touch module is disposed on the display module. The manufacturing method of disposing a touch module on a display module includes following steps: A patterned metal layer is formed on the display module, wherein the patterned metal layer includes a plurality of metal lines, the patterned metal layer has a first region, and at least one of the metal lines in the first region has a top surface, a first sidewall, and a second sidewall opposite to the first sidewall. An antireflection layer is formed on the first region, wherein the antireflection layer covers the top surface, the first sidewall, and the second sidewall of the at least one of the metal lines in the first region.

The above and other aspects of the present disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a touch display device according to an embodiment of the present disclosure.

FIG. 2 is a schematic diagram of a touch display device according to another embodiment of the present disclosure.

FIGS. 3A-3E are schematic diagrams of a manufacturing method of a touch display device according to an embodiment of the present disclosure.

FIGS. 4A-4E are schematic diagrams of a manufacturing method of a touch display device according to another embodiment of the present disclosure.

FIGS. 5A-5F are schematic diagrams of a manufacturing method of a touch display device according to an alternate embodiment of the present disclosure.

### DETAILED DESCRIPTION OF THE INVENTION

According to the touch display device disposed in the embodiments of the present disclosure, the antireflection layer covers a top surface and two sidewalls of at least one of the metal lines of the patterned metal layer and is capable of completely covering the patterned metal layer so as to reduce reflection of the light on the display surface and increase the display quality of the touch display device. Detailed descriptions of the present disclosure are disclosed below with accompanying drawings. In the accompanying drawings, the same or similar reference numerals are used to represent the same or similar elements. It should be noted that the accompanying drawings are simplified so that the contents of the embodiments can be more clearly described. Also, detailed structures disclosed in the embodiments are for exemplification purpose only, not for limiting the scope of protection of the present disclosure. Anyone who is skilled in the technology field of the present disclosure can make necessary modifications or variations to these structures according to the needs in actual implementations.

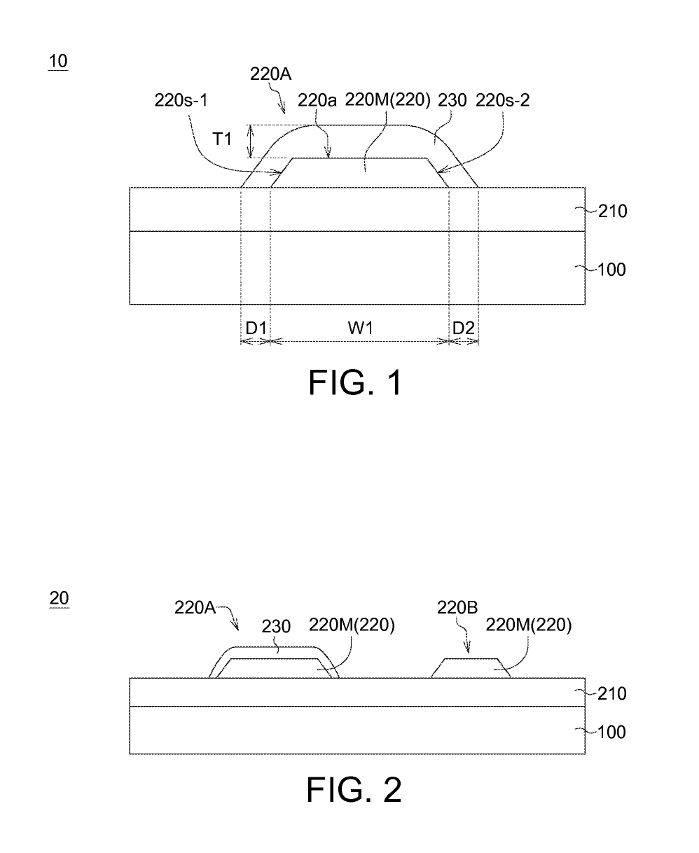

FIG. 1 is a schematic diagram of a touch display device according to an embodiment of the present disclosure. As indicated in FIG. 1, the touch display device 10 includes a display module 100 and a touch module 200 disposed on the display module 100. The touch module 200 includes a patterned metal layer 220 and an antireflection layer 230. The patterned metal layer 220 includes a plurality of metal lines 220M, and the patterned metal layer 220 has a first region 220A. At least one of the metal lines 220M has a top surface 220a, a first sidewall 220s-1, and a second sidewall 220s-2 opposite to the first sidewall 220s-1. The antireflection layer 230 is formed on the first region 220A, and the antireflection layer 230 covers the top surface 220a, the first sidewall 220s-1, and the second sidewall 220s-2 of at least one of the metal lines 220M in the first region 220A. It should be noted that FIG. 1 only illustrates a metal line 220M to more clearly describe the present disclosure. In some embodiments, the antireflection layer 230 may cover the top surface 220a, the first sidewall 220s-1, and the second sidewall 220s-2 of each of the metal lines 220M in the first region 220A.

In the present embodiment as indicated in FIG. 1, the touch module 200 may further include a substrate 210, and the patterned metal layer 220 is formed on the substrate 210. In another embodiment, the touch module 200, not including any additional substrate (not illustrated in the diagram), is directly formed on the display module 100. For example, the touch module 200 can be directly formed on a color filter glass substrate, which can be shared by the display module 100 and the touch module 200 (not illustrated in the diagram).

In an embodiment, the pattern of the antireflection layer 230 substantially corresponds to the pattern of the first region 220A of the patterned metal layer 220, and the antireflection layer 230 completely covers the first region 220A of the patterned metal layer 220. Thus, the reflection of lights on the display surface of the display module 100 can be reduced, and the display quality of the touch display device 10 can be increased.

In the embodiment, as indicated in FIG. 1, the antireflection layer 230 extends outwards by a first distance D1 and a second distance D2 respectively along the first sidewall 220s-1 and the second sidewall 220s-2, and the difference between the first distance D1 and the second distance D2 is, for example, less than or equal to 0.3 microns (μm). That is, the first distance D1 and the second distance D2 are nearly equivalent to each other, and the absolute value of the difference between the first distance D1 and the second distance D2 is less than or equal to 0.3 μm.

In the embodiment, as indicated in FIG. 1, the first distance D1 and the second distance D2 respectively are, for example, greater than 0 μm to 3 μm.

As indicated in FIG. 1, the metal line 220M has a width W1. In an embodiment, the width W1 is, for example, 2-10 μm. In another embodiment, the width W1 is, for example, 3-5 μm. In the embodiment, as indicated in FIG. 1, the metal line 220M has a trapezoidal cross-section, and the width W1 refers to the bottom length of the trapezoid.

In the embodiment, the patterned metal layer 220 may have a single-layer structure or a multi-layer structure. In the embodiment, the patterned metal layer 220 may include pure metal, alloy, metal nitride, metal oxide, metal oxynitride or a combination of any two or more thereof.

In an embodiment, the antireflection layer 230 may include a thermosetting organic material or a semi-thermosetting organic material, such as a photoresist material used for a black matrix (BM). Moreover, the antireflection layer 230 has a transmittance ranging between 0.1%-50% of a light with a wavelength of 380-780 nm. The antireflection layer 230 blocks most of the light and prevents it from reaching the patterned metal layer 220; hence the effect of antireflection is achieved.

In the embodiment, as indicated in FIG. 1, the antireflection layer 230, which covers on the top surface 220a of the metal line 220M in the first region 220A, has a thickness T1 of greater than or equal to 2000 Å but less than or equal to 20000 Å. If the thickness T1 of the antireflection layer 230 is less than 2000 Å, the antireflection layer 230 may have insufficient blocking effect against the penetrating light.

In the embodiment, the material of the substrate 210 may include glass, ethylene terephthalate (PET) or poly methyl methacrylate (PMMA). However, the material of the substrate 210 is determined according to actual needs and is not limited to the above exemplifications.

In the embodiment, the display module 100 may include a display panel, such as an organic light emitting diode display panel or a liquid crystal display panel. The touch module 200 is not necessarily to be disposed on the viewing region of the display module 100. For example, the touch module 200 can also be disposed on the tracing region.

FIG. 2 is a schematic diagram of a touch display device 20 according to another embodiment of the present disclosure. For elements identical or similar to above embodiments, the same or similar reference numerals are used, and the descriptions thereof can be made with reference to above disclosure and are not repeated here.

As indicated in FIG. 2, in the touch display device 20, the patterned metal layer 220 further has a second region 220B in which the patterned metal layer 220 is exposed outside the antireflection layer 230. That is, the metal line(s) 220M of the patterned metal layer 220 in the second region 220B is not covered by the antireflection layer 230 and can thus be used for electrical connection.

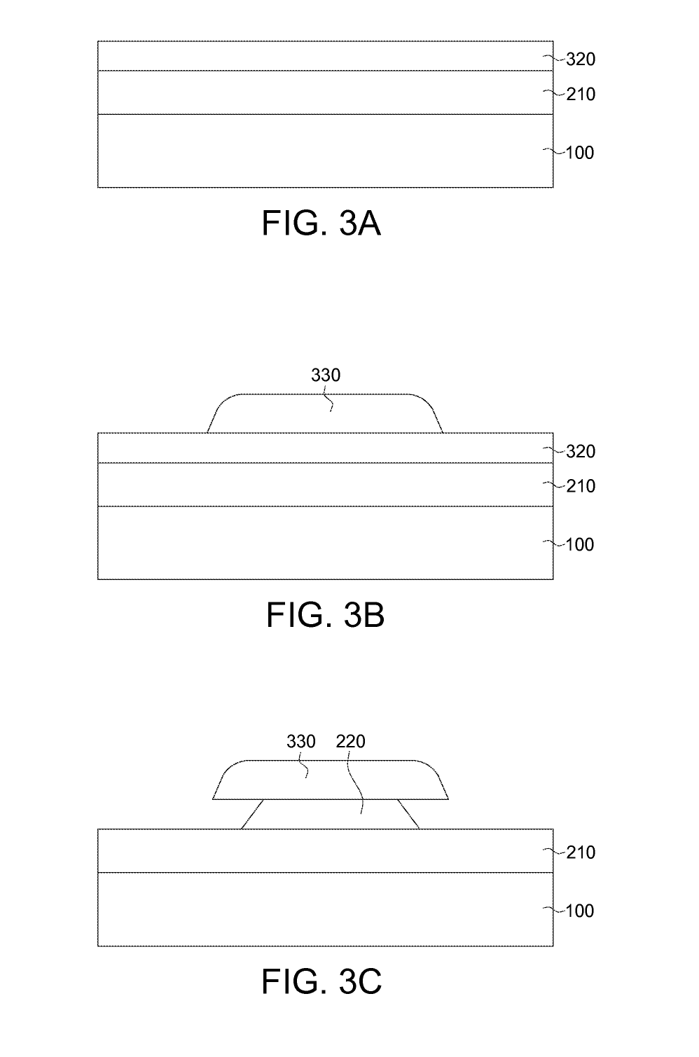

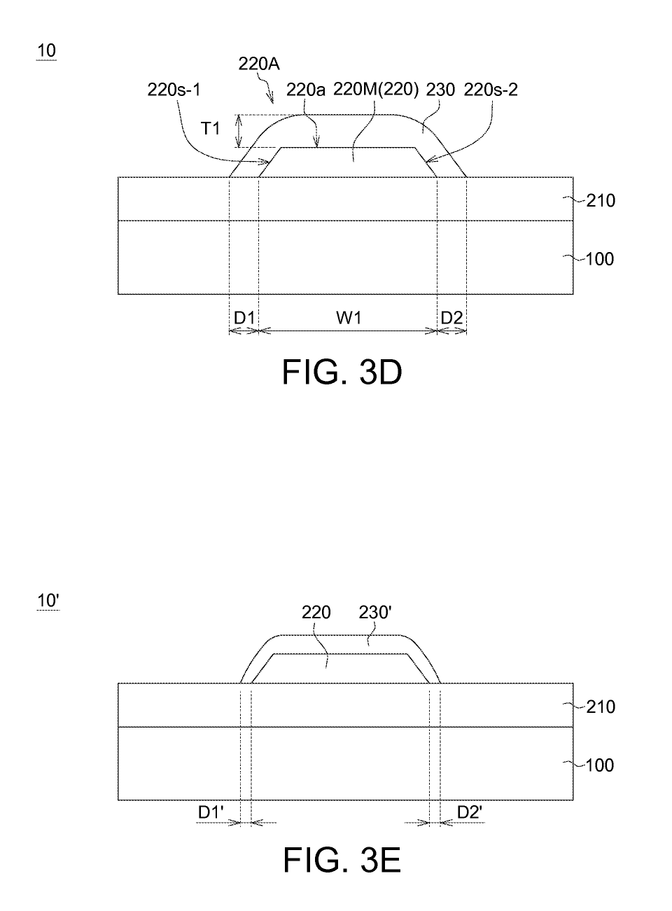

FIGS. 3A-3E are schematic diagrams of a manufacturing method of a touch display device according to an embodiment of the present disclosure. For elements identical or similar to above embodiments, the same or similar reference numerals are used, and the descriptions thereof can be made with reference to above disclosure and are not repeated here.

Referring to FIGS. 3A-3E, a display module 100 is provided, and a touch module 200 is disposed on the display module 100. In the embodiment, the manufacturing method of disposing the touch module 200 on the display module 100 includes such as the following steps.

Firstly, in the present embodiment as indicated in FIG. 3A, a substrate 210 is provided and disposed on the display module 100. In another embodiment, there is no need to provide any additional substrates.

Then, in the present embodiment as indicated in FIGS. 3A-3C, a patterned metal layer 220 is formed on the substrate 210. In the embodiment, the patterned metal layer 220 once formed may include a plurality of metal lines 220M, and the manufacturing method of forming the patterned metal layer 220 is exemplified by using one metal line 220M. In the present embodiment, the manufacturing method of forming the patterned metal layer 220 includes such as the following steps. As indicated in FIG. 3A, a metal layer 320 is formed on the substrate 210. Then, as indicated in FIG. 3B, an antireflection material layer 330 is formed on the metal layer 320. Then, as indicated in FIG. 3C, the metal layer 320 is etched according to the pattern of the antireflection material layer 330 to form the patterned metal layer 220. The patterned metal layer 220 once formed has a first region 220A. In the embodiment, the metal layer 320 can be etched using a dry etching process, a wet etching process or multiple repeats of dry etching process in conjunction with a wet etching process. In another embodiment, the patterned metal layer 220 can be directly formed on the display module 100 instead of being formed on the substrate 210.

Then, as indicated in FIG. 3D, an antireflection layer 230 is formed on the first region 220A, wherein the antireflection layer 230 covers a top surface 220a and two sidewalls 220s-1 and 220s-2 of the metal line 220M in the first region 220A.

In the embodiment, the manufacturing method of forming the antireflection layer 230 includes such as the following steps. The antireflection layer 330 is formed of a thermosetting organic material or a semi-thermosetting organic material, and after the metal layer 320 is etched, the antireflection layer 330 is heated. During the heating process, the thermosetting or semi-thermosetting antireflection layer 330, having not completely cross-linked and hardened, will flow towards two sidewalls 220s-1 and 220s-2 from the top surface 220a of the metal line 220M in the first region 220A and eventually covers the two sidewalls. In an embodiment, the antireflection layer 330 is formed of a photoresist material used for a black matrix, and the antireflection layer 330 is heated at a temperature of such as about 230° C. However, the range of the heating temperature depends on whether the antireflection layer 330 is formed of a thermosetting organic material or a semi-thermosetting organic material, and is not limited to the temperature range exemplified above.

At this stage, the touch display device 10 as indicated in FIG. 1 is formed. The antireflection layer 230 extends outwards by a first distance D1 and a second distance D2 respectively along the first sidewall 220s-1 and the second sidewall 220s-2, and the difference between the first distance D1 and the second distance D2 is less than or equal to 0.3 μm. The first distance D1 and the second distance D2 respectively are greater than 0 μm to 3 μm.

According to conventional manufacturing methods, metal lines and black photoresist (antireflection layer) are respectively defined by different photoresists. During the two photoresist exposure processes, the alignments of masks may overlay (OL), and the width (critical dimension, CD) may change. To avoid the influence caused by alignment errors, the widths of the masks must be increased, such that the metal reflection, which would otherwise arise if the black photoresist fail to completely cover the metal lines, can be avoided. Thus, the width of the black photoresist must be considerably greater than that of the metal lines.

On the contrary, according to the embodiments of the present disclosure, the patterned metal layer 220 is defined by the antireflection layer 330 formed of a thermosetting or semi-thermosetting material, and the thermosetting or semi-thermosetting antireflection layer 330 can flow to completely cover the metal disposed underneath. Since the thermosetting or semi-thermosetting antireflection layer 330 uniformly flows downwards, the difference between the first distance D1 and the second distance D2 can be very small. Therefore, only one photoresist exposure process would suffice to avoid the influence caused by the alignment errors from applying two masks. Accordingly, the width of the black photoresist can be reduced, and the aperture ratio of the display can be increased. Therefore, in the applications of the touch devices according to the present disclosure, visibility is effectively improved, the steps of manufacturing process are reduced, and thus the manufacturing cost is reduced, and production capacity is increased.

Next, as indicated in FIG. 3E, the antireflection layer 230 can be optionally annealed with a plasma to thin the antireflection layer 230 in the first region 220A and form the touch display device 10′ as indicated in FIG. 3E. Thus, the first distance D1′ and the second distance D2′ of the touch display device 10′ can respectively be smaller than the first distance D1 and the second distance D2 of the touch display device 10, and the width of the black photoresist can be further reduced.

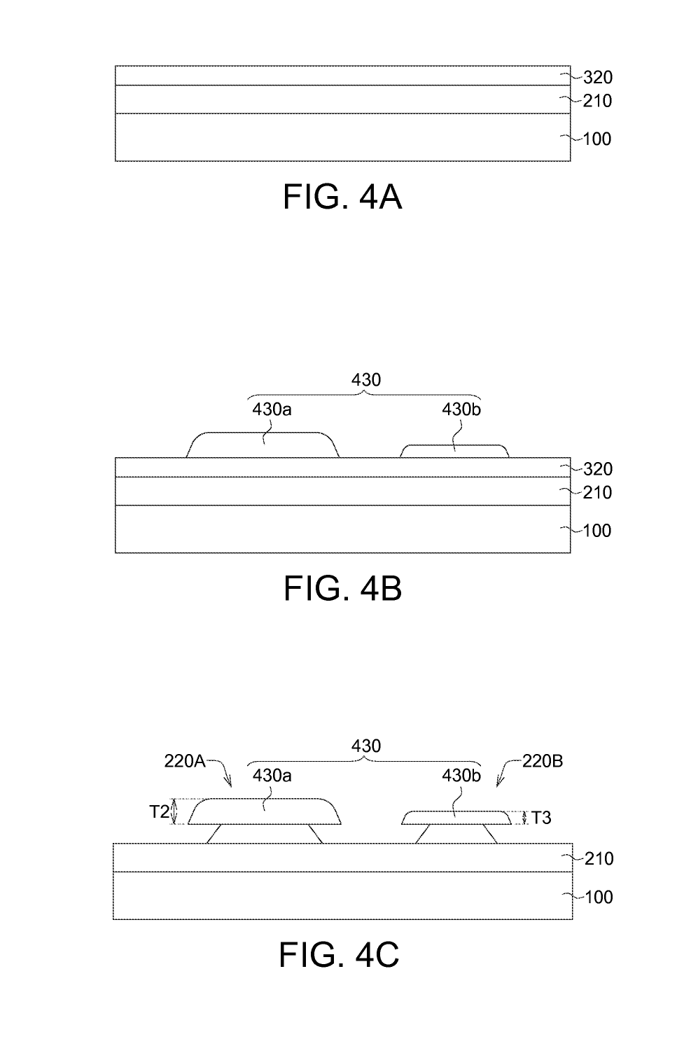

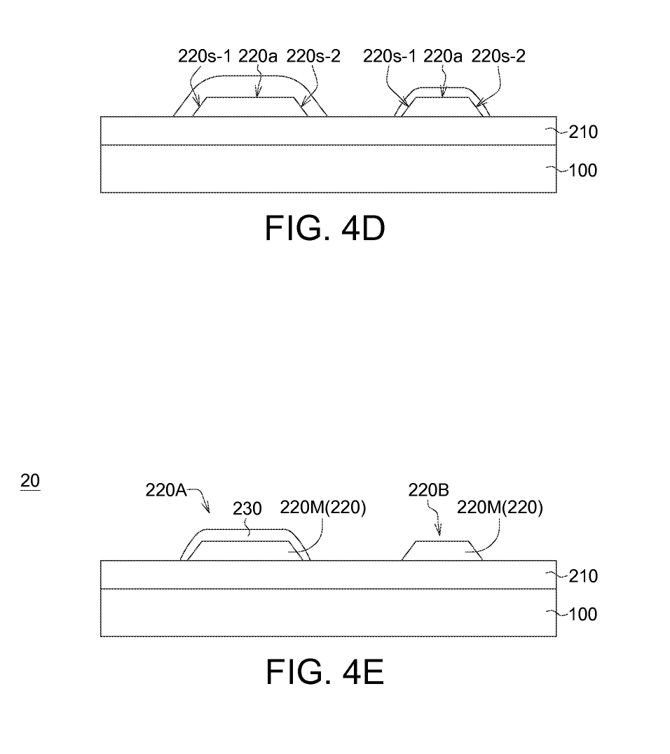

FIGS. 4A-4E are schematic diagrams of a manufacturing method of a touch display device according to another embodiment of the present disclosure. For elements identical or similar to above embodiments, the same or similar reference numerals are used, and the descriptions thereof can be made with reference to above disclosure and are not repeated here.

Firstly, in the present embodiment as indicated in FIG. 4A, a substrate 210 disposed on the display module 100 is provided. In another embodiment, there is no need to provide any additional substrates.

Then, in the present embodiment as indicated in FIGS. 4A-4C, a patterned metal layer 220 is formed on the substrate 210. In the embodiment, the patterned metal layer 220 may include a plurality of metal lines 220M, and the manufacturing method of the patterned metal layer 220 is exemplified by one metal line 220M. In another embodiment, the patterned metal layer 220 can be directly formed on the display module 100 instead of on the substrate 210. In the present embodiment, the formation process of the patterned metal layer 220, for example, includes the following steps.

As indicated in FIG. 4A, in the present embodiment, a metal layer 320 is formed on the substrate 210. Then, as indicated in FIG. 4B, an antireflection material layer 430 is formed on the metal layer 320 corresponding to the first region 220A and the second region 220B of the patterned metal layer 220 which will be subsequently formed. The part 430A of the antireflection material layer 430 formed on the first region 220A has a larger thickness T2, and the part 430B of the antireflection material layer 430 formed on the second region 220B has a smaller thickness T3. Such thickness difference can be achieved as follows. An ordinary mask and a gray tone mask are respectively disposed in the first region 220A and in the second region 220B after the patterned metal layer 220 is coated with an antireflection material. Then, the ordinary mask and the gray tone mask are further exposed and developed.

Then, as indicated in FIG. 4C, the metal layer 320 is etched according to the pattern of the antireflection material layer 430 to form a patterned metal layer 220. The patterned metal layer 220 once formed has a first region 220A and a second region 220B. In an embodiment, the metal layer 320 can be etched by using a dry etching process, a wet etching process or multiple repeats of dry etching process in conjunction with a wet etching process.

Then, as indicated in FIG. 4D, in the embodiment, the antireflection material layer 430 is formed of a thermosetting organic material or a semi-thermosetting organic material, and after the metal layer 320 is formed, the antireflection material layer 430 is heated. During the heating process, before the thermosetting or semi-thermosetting antireflection material layer 430 is completely hardened, the antireflection material layer 430 will flow towards two sidewalls 220s-1 and 220s-2 from a top surface 220a of the metal line 220M and covers the two sidewalls. In an embodiment, the antireflection layer 430 is formed of a photoresist material used for a black matrix and heated at about such as 230° C. However, the temperature range of the heating process depends on whether the antireflection material layer 430 is formed of a thermosetting organic material or semi-thermosetting organic material and is not limited to the temperature range exemplified above.

Next, as indicated in FIG. 4E, the antireflection material layer 430 is annealed with a plasma to remove the part 430B of the antireflection material layer 430 in the second region 220B and thin the part 430A of the antireflection material layer 430 in the first region 220A to form the antireflection layer 230. Meanwhile, the patterned metal layer 220 in the second region 220B is exposed outside the antireflection layer 230. As indicated in FIG. 4E, the antireflection layer 230 is formed on the first region 220A and the second region 220B of the patterned metal layer 220, and the antireflection layer 230 covers a top surface 220a and two sidewalls 220s-1 and 220s-2 of the metal line 220M in the first region 220A.

Thus, the touch display device 10 as indicated in FIG. 4E is formed. The antireflection layer 230 extends outwards by a first distance D1 and a second distance D2 respectively along the first sidewall 220s-1 and the second sidewall 220s-2, and the difference between the first distance D1 and the second distance D2 is less than or equal to 0.3 μm. The first distance D1 and the second distance D2 respectively are greater than 0 μm to 3 μm.

According to the embodiments of the present disclosure, the patterned metal layer 220 is defined by the antireflection layer 330 formed of a thermosetting or semi-thermosetting material, and the thermosetting or semi-thermosetting antireflection layer 430 can flow to completely cover the metal disposed underneath. Since the thermosetting or semi-thermosetting antireflection layer 430 uniformly flows downwards, the difference between the first distance D1 and the second distance D2 can be very small. Therefore, only one photoresist exposure process would suffice to avoid the influence caused by the alignment errors from applying two masks. Accordingly, the width of the black photoresist can be reduced, and the aperture ratio of the display can be increased. Therefore, in the applications of the touch devices according to the present disclosure, visibility is effectively improved, the steps of manufacturing process are reduced, and thus the manufacturing cost is reduced, and production capacity is increased.

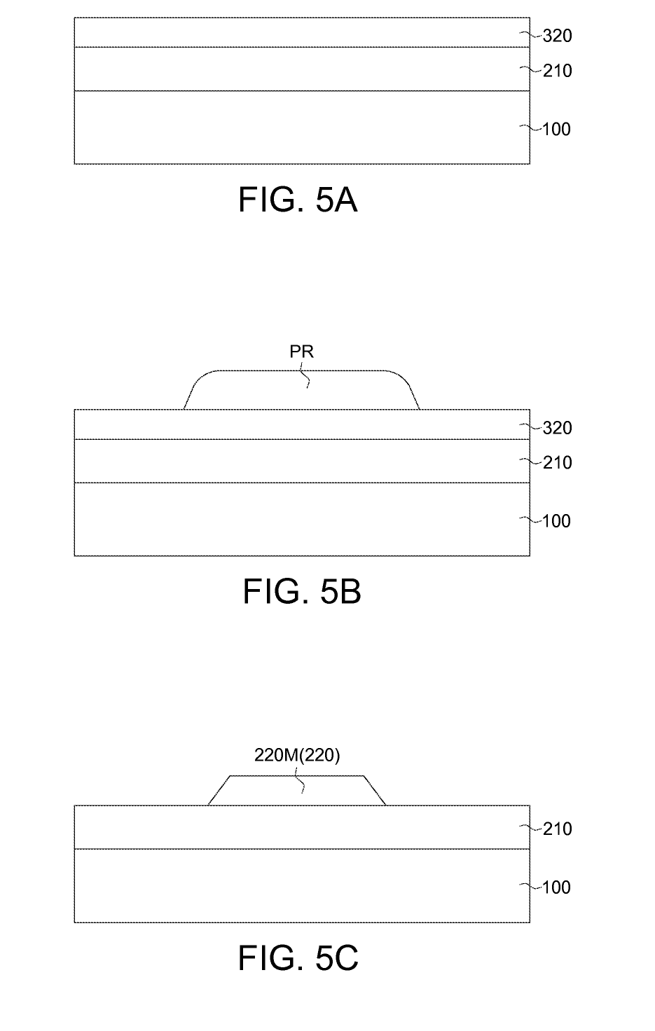

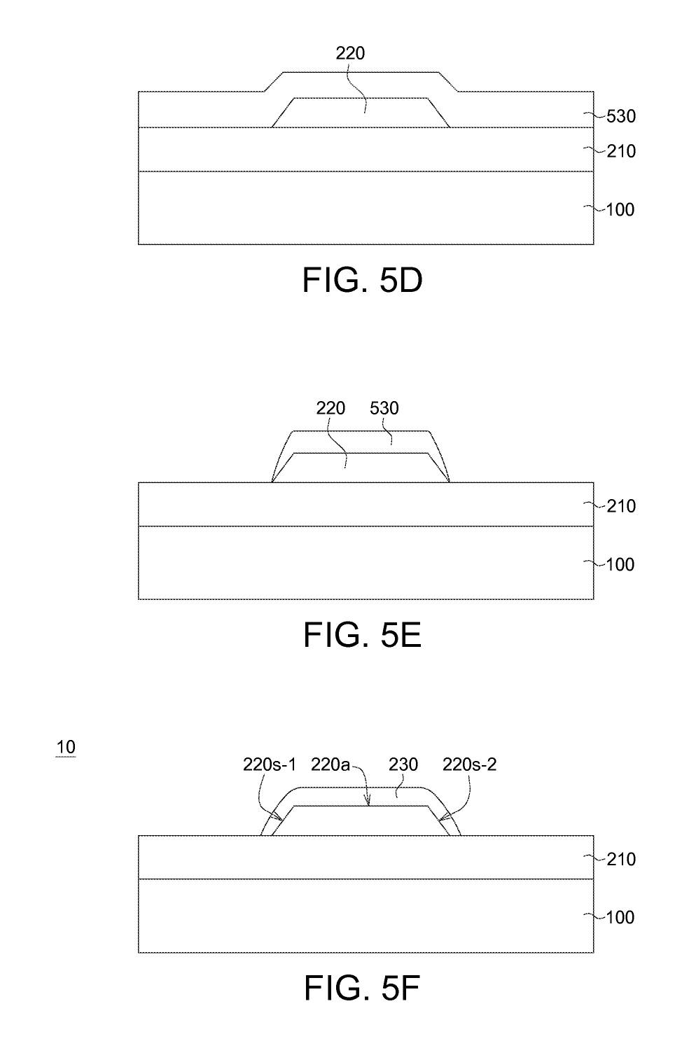

FIGS. 5A-5F are schematic diagrams of a manufacturing method of a touch display device according to an alternate embodiment of the present disclosure. For elements identical or similar to above embodiments, the same or similar reference numerals are used, and the descriptions thereof can be made with reference to above disclosure and are not repeated here.

Referring to FIGS. 5A-5F, a display module 100 is provided, and a touch module 200 is disposed on the display module 100. In the embodiment, the manufacturing method of disposing the touch module 200 on the display module 100 includes such as the following steps.

Firstly, in the present embodiment as indicated in FIG. 5A, a substrate 210 disposed on the display module 100 is provided. In another embodiment, there is no need to provide any additional substrates.

Then, in the present embodiment as indicated in FIGS. 5A-5C, a patterned metal layer 220 is formed on the substrate 210. In the embodiment, the patterned metal layer 220 once formed may include a plurality of metal lines 220M, and the manufacturing method of forming the patterned metal layer 220 is exemplified by using one metal line 220M. In the present embodiment, the manufacturing method of forming the patterned metal layer 220 includes such as the following steps: As indicated in FIG. 5A, a metal layer 320 is formed on the substrate 210. Next, as indicated in FIG. 5B, a photoresist layer PR is formed on the metal layer 320. Then, as indicated in FIG. 5C, the metal layer 320 is etched according to the pattern of the photoresist layer PR to form the patterned metal layer 220, and then the photoresist layer PR is removed. The patterned metal layer 220 once formed has a first region 220A. In the embodiment, the metal layer 320 can be etched using a dry etching process, a wet etching process or multiple repeats of dry etching process in conjunction with a wet etching process. In another embodiment, the patterned metal layer 220 can be directly formed on the display module 100 instead of being formed on the substrate 210.

Then, as indicated in FIGS. 5D-5F, an antireflection layer 230 is formed on the first region 220A, and the antireflection layer 230 covers a top surface 220a and two sidewalls 220s-1 and 220s-2 of the metal line 220M in the first region 220A.

In the embodiment, the manufacturing method of forming the antireflection layer 230 includes such as the following steps. As indicated in FIG. 5D, an antireflection material layer 530 is formed on the patterned metal layer 220. Then, as indicated in FIG. 5D, a part of the antireflection material layer 530 is removed according to the pattern of the patterned metal layer 220. In the embodiment, the patterned metal layer 220 is used as a mask with which the back side of the antireflection material layer 530 is exposed and developed.

Then, as indicated in FIG. 5E, the antireflection material layer 530 is formed of a thermosetting organic material or a semi-thermosetting organic material, and after a part of the antireflection material layer 530 is removed, the antireflection material layer 530 is heated. During the heating process, the antireflection material layer 530 flows from a top surface 220a towards two sidewalls 220s-1 and 220s-2 of the metal line 220 in the first region 220A and covers the two sidewalls. In an embodiment, the antireflection material layer 530 is formed of a black matrix photoresist material, and the antireflection material layer 530 is heated at a temperature of about such as 230° C. However, the temperature range of the heating process depends on whether the antireflection material layer 530 is formed of a thermosetting organic material or semi-thermosetting organic material and is not limited to the temperature range exemplified above.

Thus, the touch display device 10 as indicated in FIG. 5E is formed.

The antireflection layer 230 extends outwards by a first distance D1 and a second distance D2 respectively along the first sidewall 220s-1 and the second sidewall 220s-2, and the difference between the first distance D1 and the second distance D2 is less than or equal to 0.3 μm. The first distance D1 and the second distance D2 respectively are greater than 0 μm to 3 μm.

According to the embodiments of the present disclosure, the thermosetting or semi-thermosetting antireflection material layer 530 can flow to completely cover the metal disposed underneath, such that the influence caused by alignment errors from the masks can be effectively avoided, the width of the black photoresist can be reduced, and the aperture ratio of the display can be increased. Therefore, in the applications of the touch devices according to the present disclosure, visibility is effectively improved, the steps of manufacturing process are reduced, and thus the manufacturing cost is reduced, and production capacity is increased.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch display device, comprising:
a display module; and
a touch module disposed on the display module, wherein the touch module comprises:
a patterned metal layer having a first region, wherein the patterned metal layer comprises a plurality of metal lines, and at least one of the metal lines in the first region has a top surface, a first sidewall, and a second sidewall opposite to the first sidewall; and
an antireflection layer formed on the first region, wherein the antireflection layer covers the top surface, the first sidewall, and the second sidewall of the at least one of the metal lines in the first region.

2. The touch display device according to claim 1, wherein the antireflection layer extends outwards by a first distance and a second distance respectively along the first sidewall and the second sidewall, a difference between the first distance and the second distance is less than or equal to 0.3 microns (μm), and the first distance and the second distance respectively are greater than 0 to 3 μm.

3. The touch display device according to claim 1, wherein each of the metal lines has a width of 2-10 μm.

4. The touch display device according to claim 3, wherein the width of each of the metal lines is 3-5 μm.

5. The touch display device according to claim 1, wherein the antireflection layer has a transmittance ranging between 0.1%-50% of a light with a wavelength of 380-780 nm.

6. The touch display device according to claim 1, wherein the antireflection layer comprises a thermosetting organic material or a semi-thermosetting organic material.

7. The touch display device according to claim 1, wherein the patterned metal layer has a single-layer structure or a multi-layer structure, and the patterned metal layer comprises pure metal, alloy, metal nitride, metal oxide, metal oxynitride or a combination of any two thereof.

8. The touch display device according to claim 1, wherein the antireflection layer covering the top surface of the at least one of the metal lines in the first region has a thickness of greater than or equal to 2000 Å and less than or equal to 20000 Å.

9. A manufacturing method of a touch display device, comprising:
providing a display module; and
disposing a touch module on the display module, comprising:
forming a patterned metal layer on the display module, wherein the patterned metal layer comprises a plurality of metal lines, the patterned metal layer has a first region, and at least one of the metal lines in the first region has a top surface, a first sidewall, and a second sidewall opposite to the first sidewall; and
forming an antireflection layer on the first region, wherein the antireflection layer covers the top surface, the first sidewall, and the second sidewall of the at least one of the metal lines in the first region.

10. The manufacturing method of the touch display device according to claim 9, further comprising:
annealing the antireflection layer with a plasma to thin the antireflection layer on the first region.
